(19) United States
(12) Patent Application Publication
(10) Pub. No.: US 2006/0259313 A1
(43) Pub. Date: Nov. 16, 2006

(54) Enhanced brochure display stands

(75) Inventors: Barry Michael Luden, Stamford, CT (US); Andrew Philip Cook, Hamilton (CA)

Correspondence Address: Paul D. Greeley;Ohlandt, Greeley, Ruggiero & Perle, L.L.P., 10th Floor, One Landmark Square, Stamford, CT, 06901-2682, US

(73) Assignee: IDT Corporation

(21) Appl. No.: 11/342,214

(22) Filed: Jan. 27, 2006

Related U.S. Application Data
(60) Provisional application No. 60/680,713, filed on May 13, 2005.

(51) Int. Cl. G06Q 99/00

(52) U.S. Cl. 705/1

(57) ABSTRACT

An interactive, enhanced brochure display stand is provided. The display stand includes both traditional printed brochures as well as multimedia content delivered through any number of communication devices providing multisensory stimulation to a consumer. The communication devices may also include input devices allowing the consumer to interact with the display stand by selecting content to be experienced as well as initiating and completing sales transactions.

### CROSS REFERENCE TO RELATED APPLICATION

This application claims priority to U.S. Provisional Patent Application No. 60/680,713 filed on May 13, 2005.

### BACKGROUND OF THE INVENTION

1. Field of the Invention

The present disclosure relates to brochure display stands. More particularly, the present disclosure relates to brochure display stands enhanced with multisensory communication devices.

2. Description of Related Art

Printed brochures are an effective method of marketing goods or services. Commonly, such printed brochures are displayed to a user via a stand. For example, brochure display stands can be found in many hotels, airports, train stations, highway rest areas, malls, cafeterias, stores (e.g., sporting goods stores), and the like.

The display stand can provide any number of printed brochures that may be of interest to passersby. Thus, the display stands offer free, static printed brochures to the consumer. Brochure stands may typically house between 60 to 130 brochures, all competing for the attention of the consumer through the use of size, graphical design, color and position relative to viewing eye level.

Unfortunately, the printed brochures in prior-art display stands must be changed periodically to ensure that the information they convey is not outdated. For example, such printed-brochure display stands have not proven effective for communicating “limited time offers” or “special events.” In addition, tourists are increasingly using web-based sources at home before traveling, potentially reducing their reliance on brochure stands during their trip.

There is a continuing need for systems and methods to enhance consumers' use of brochure display stands that address the problems associated with the prior art.

### BRIEF SUMMARY OF THE INVENTION

It is an object of the present disclosure to provide a brochure stand enhanced with one or more communication devices.

It is another object to provide a print and digital brochure stand that adds multimedia, including audio, graphical, and video enhancements that are synergistic with the print media traditionally marketed via the brochure stand.

It is a further object to provide a network connected stand enhanced with one or more multimedia communication devices. The communication devices can include video screens, input devices, output devices, speakers, printers, network connectivity devices, proximity sensors, brochure sensors, payment devices, and any combination thereof.

It is a further object to provide a printed brochure stand enhanced with one or more brochure detection devices.

The above described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a perspective view of a prior-art display stand;

FIG. 2 is a perspective view of an exemplary embodiment of an enhanced display stand according to the present disclosure having a video communication device;

FIG. 3 is a side view of the enhanced display stand of FIG. 2;

FIG. 4 is a front view of an alternative exemplary embodiment of the enhanced display stand of FIG. 2 having a scanner and printer; and

FIG. 5 is a front view of another alternate exemplary embodiment of the enhanced display stand of FIG. 2 having a network connectivity device;

### DETAILED DESCRIPTION OF THE INVENTION

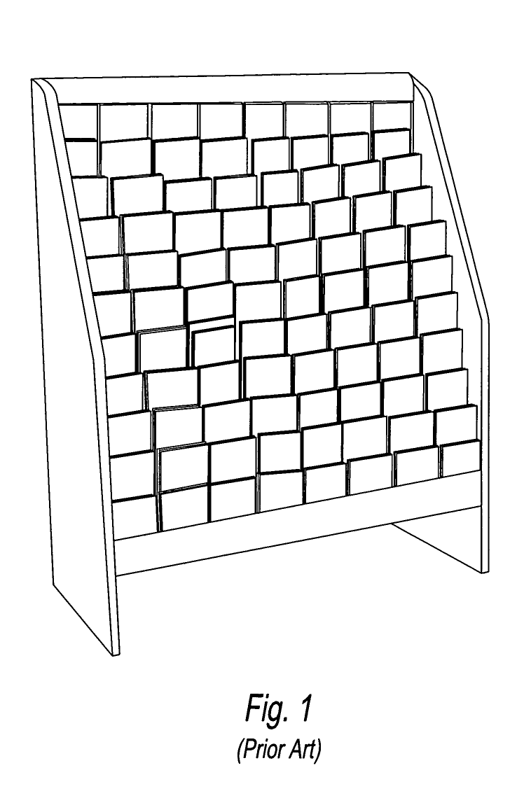

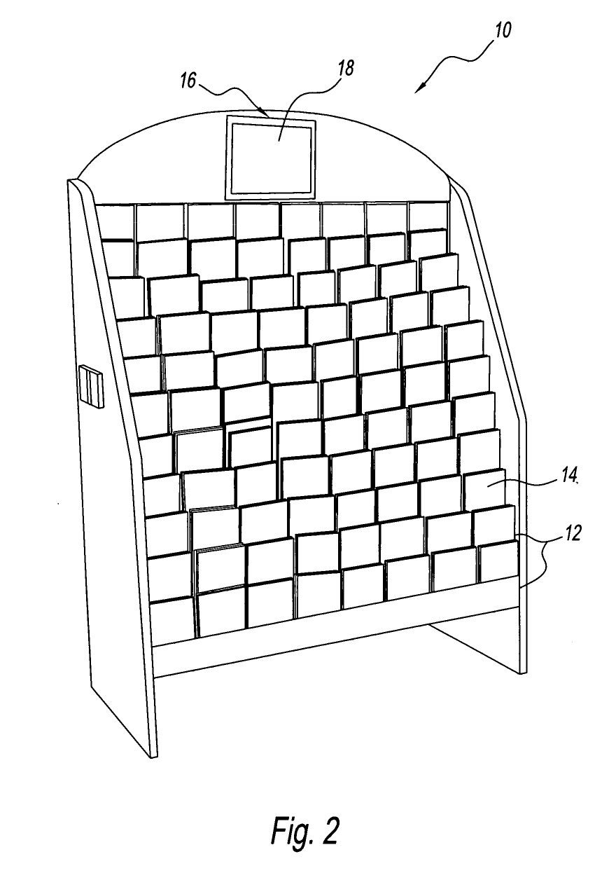

Referring to the drawings and in particular to FIG. 2, an exemplary embodiment of an enhanced display stand according to the present disclosure, generally referred to by reference number 10 is shown. Similar to the prior-art stand of FIG. 1, enhanced stand 10 includes a plurality of locations 12 for receiving printed brochures 14. Advantageously, enhanced stand 10 includes one or more communication devices 16. In the embodiment of FIG. 2, enhanced stand 10 is illustrated having a single communication device 16, namely a video screen 18.

It has been determined by the present disclosure that much of the value from printed brochure stands derives from the random nature of the material available; in that sense, they resemble checkout stands in retail stores, designed to entice the consumer into making an impulse buy. However, it has also been determined by the present disclosure that consumers are beginning to rely more heavily on electronically delivered media, and less on printed matter, making traditional brochure stands less effective as a selling tool.

The synergistic combination of printed brochures 14 with other media delivered through communication devices 16 advantageously combines the familiarity of the prior-art brochure stands with the multimedia experience that current consumers demand. This combination enhances the impulse-buy characteristic of the prior-art brochure stands. With the present invention, consumers will more likely be drawn to the stand, and are more likely to initiate a transaction or purchase the advertised products or services.

Video screen 18 can display ongoing visual communication (e.g., images and/or video) relating to the content of one or more brochures in the stand, to nearby attractions, or to media, news, or other content unrelated to the brochures in the stand.

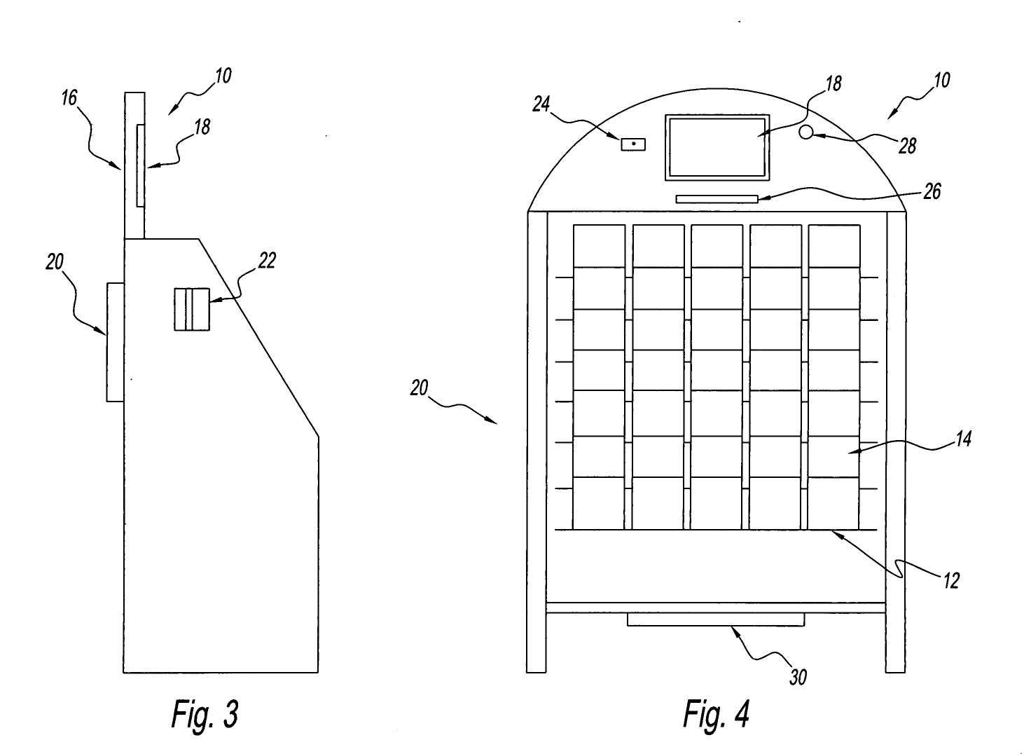

Referring to FIG. 3, enhanced stand 10 can include an electronic controller 20, such as a computer, which interfaces with communication device 16. Controller 20 can control the hardware and software necessary for operation of communication device 16. For example, controller 20 can include a processor plus a memory device and/or storage device such as, but not limited to, a CD drive, a DVD drive, a solid-state memory device (e.g., ROM, EPROM, EEPROM, Compact Flash Memory), and any combination thereof. In this manner, controller 20 can display media resident on the controller or its storage devices to a user via screen 18.

Stand 10 can also include communication device 16 that operates as a payment device 22 in communication with controller 20. Payment device 22 can be any known payment device such as, but not limited to, a currency operated device, a coin operated device, a credit/debit card device, a debit pin pad, a signature pad, and others. In this manner, a user can use stand 10 to pay for such products as specialized maps, books, newspapers, hotel reservations, rental-car reservations, and others.

In an exemplary embodiment, communication device 16 can include an input device to allow the user to provide inputs to controller 20. For example, video screen 18 can be a touch screen allowing the user to provide inputs to controller 20. It should be recognized that stand 10 is described by way of example having an input device included as part of communication device 16. Of course, it is contemplated by the present disclosure for stand 10 to include an input device (not shown) separate from communication device 16 or any combination thereof. The input device enables the consumer to select or browse through the visual media resident on controller 20 or its storage devices via screen 18.

In another embodiment depicted in FIG. 4, communication device 16 can be an input device in the form of a scanner 24 interfacing with controller 20. Scanner 24 can allow a user to scan a code, such as a bar code, printed on brochure 14. Controller 20 can detect which brochure 14 has been scanned by scanner 22, can associate that brochure with one or more visual media resident on controller 20 or its storage devices, and can display the associated media on video screen 18.

Scanner 24 can be any known scanning device such as, but not limited to, passive devices (e.g., optical lens and code-recognition abilities) or active devices (e.g., active lasers that assists in scanning the relevant coded area of the brochures in adverse illumination). Scanner 24 can be affixed to enhanced stand 10 as depicted in FIG. 4 or can be attached to the stand and in communication with controller 20 (e.g., a scanning wand or light-pen).

Scanner 24 can also be used to authorize access to controller 20. For example, scanner 24 can allow controller 20 to authenticate maintenance personnel having identity tags that can be read by the scanner to limit access to particular features of enhanced stand 10.

In some embodiments, communication device 16 can include an output device in the form of a printer 26 in communication with controller 20. Printer 26 can provide a user with a printed coupon, a reservation confirmation, a receipt, a custom map (e.g., directions from stand 10 to an attraction), an insert for updating information in brochure 14, and others. Printer 26 can be any known printing device such as, but not limited to, a thermal printer, an inkjet printer, laser printer, and others. In addition, printer 26 can be a monochrome printer, a color printer, or any combination thereof.

In addition, it is contemplated by the present disclosure for communication device 16 to include other output devices. For example, communication device 16 can be an olfactory device 28 configured to communicate with a consumer's sense of smell. In this example, stand 10 could expose a user who scans brochure 14 advertising a beach vacation to a scent associated with the beach, such as coconut oil. In another example, communication device 16 can be a temperature-regulating output device 30 so that stand 10 can expose users scanning brochure 14 advertising a beach vacation to an increased temperature, while exposing users selecting a brochure advertising a ski vacation to a reduced temperature.

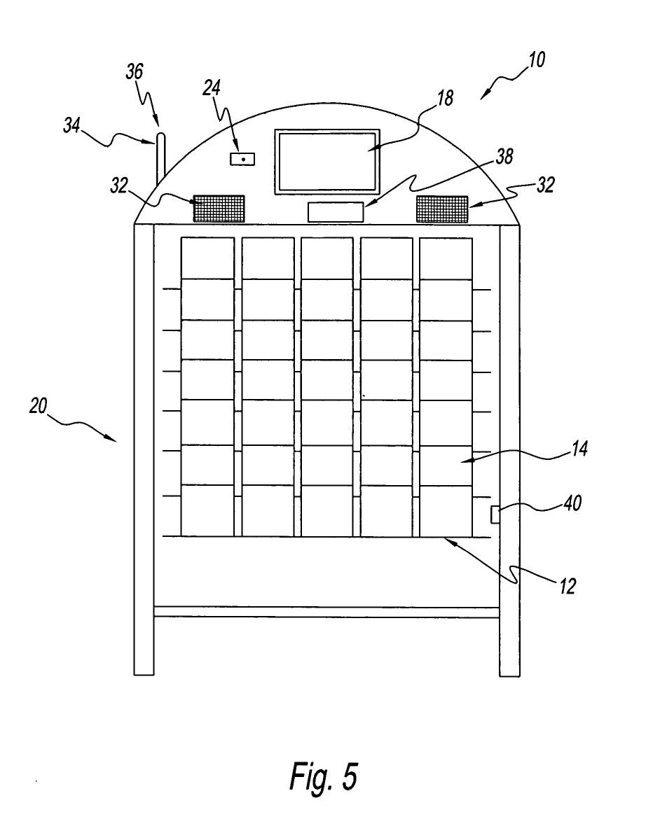

Referring now to FIG. 5, communication device 16 is illustrated as one or more audio speakers 32. In this manner, enhanced stand 10 can use speakers 32 to play audio content to attract attention and/or to provide information complementary to the content of brochures 14.

For purposes of clarity, stand 10 is illustrated having speakers 32 in addition to screen 18 and scanner 24. Of course, it is contemplated by the present disclosure that enhanced stand 10 may include any combination of communication devices described herein. For example, it is contemplated by the present disclosure for enhanced stand 10 to include only speakers 32. Preferably, speakers 32 interface with and are driven by controller 20.

In other embodiments, speakers 32 can be replaced by and/or enhanced by short-range wireless communications with the brochure-stand user. In one embodiment, a short-range FM transmitter is used instead of the speakers described above. The signals from the transmitter are received by appropriate user equipment such as radio receivers, MP3 players with built-in FM radios, and similarly equipped PDAs and/or cellphones. In another embodiment, interactive wireless communications (input and multimedia output) with appropriate user compatible equipment (for example a notebook, PDA, or cellphone) is enabled through such wireless media as Bluetooth, IEEE 820.11 (WiFi), Ultra Wide-Band (UWB) and the like.

Communication device 16 is illustrated as a network connectivity device 34. For purposes of clarity, network connectivity device 34 is illustrated as an antenna 36 for wireless communication. Of course, it is contemplated by the present disclosure that network connectivity device 34 may be any device capable of communicating via wireless and/or wired connections. For example, network connectivity device 34 can include a modem, a network card present in controller 20, a wireless device, a blue-tooth enabled device, a cell phone, and any combination thereof.

Advantageously, network connectivity device 34 can connect controller 20 via a network, such as the Internet, a LAN, WAN, or others, to another computer or server operated by, for example, the brochure servicing company, its agent, or any third party. Network connectivity device 34 can connect controller 20 to the server in real time or may be used for periodic synchronization of the controller to the remote server. In this manner, controller 20 can have access to media content stored on the controller itself, as well as media content stored on the remote server. In addition, the media content resident on controller 20 can be updated from a remote site.

In addition, enhanced stand 10 having network connectivity device 34 provides the ability to add media content, transactions, associations, and software-updates by remote means. Network connectivity also allows for remote monitoring of the uptime/downtime of stand 10, proximity user reports, advertising rotation counts for both video and brochures, and other standard monitoring metrics.

Referring still to FIG. 5, additional embodiments of communication device 16 in the form of an input device are illustrated.

In one embodiment, stand 10 can include communication device 16 that operates as a proximity sensor 38 in communication with controller 20. Proximity sensor 38 detects the presence of a consumer within a predefined distance of stand 10 and inputs this information to controller 20. In this manner, stand 10 can activate screen 18 when a consumer is sensed, but can deactivate the screen when no consumer is sensed. Proximity sensor 38 can include any known sensors such as, but not limited to, an ultrasonic sensor, an optical sensor, a floor-pad sensor, and an infrared sensor.

Stand 10 can also include communication device 16 that operates as a brochure sensor 40 in communication with controller 20. Brochure sensor 40 can detect the presence or absence of brochure 14 in a particular location 12 and inputs this information to controller 20. For example, brochure sensor 40 can be a proximity sensor that detects the presence or absence of a brochure in a particular location 12. In other embodiments, brochure sensor 40 can detect the number of brochures 14 present in a particular location 12 and can input this information to controller 20. For example, brochure sensor 40 can detect the weight of brochures 14 present in a particular location 12. In this manner, stand 10 can alert maintenance staff of the need for replenishment by, for example, communication via network connectivity device 34.

It should be noted that enhanced stand 10 can include any desired number of communication devices 16. For example, the stand can include one or more: video screens, input devices, output devices, speakers, network connectivity devices, printers, proximity sensors, brochure sensors, payment devices, and any combination thereof.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

The invention claimed is:

1. A system for interacting with a consumer, the system comprising:
an interactive communication device;
a controller interfacing with the interactive communication device; and
a display stand associated with the interactive communication device.

2. An interactive display stand, comprising:
a plurality of locations for displaying printed material;
an interactive communication device;
a sensor for determining the amount of printed material present in the display stand; and
a controller interfacing with the interactive communication device and the sensor.

3. A method for selling goods and services to a consumer, comprising:
displaying printed material in an interactive display stand;
attracting the consumer to the interactive display stand through the use of multisensory content delivered via an output device, the multisensory content being related to the content of the printed material in the interactive display stand;
providing an input device to the consumer; and
allowing the consumer to select, through the input device, specific information relating to the content of the printed material in the interactive display stand.

4. The method of claim 3 further comprising initiating a sales transaction related to the content of the printed material using the input and output devices.

5. The method of claim 4 further comprising completing the sales transaction using the input and output devices.

6. An interactive display stand, comprising:
a plurality of locations for displaying printed material; and
an interactive communication system for updating and/or amplifying the content of the printed material.

7. The interactive display stand of claim 6, wherein the interactive communication system comprises:
an input device;
an output device; and
a controller interfacing with the input device and the output device.

8. The interactive display stand of claim 7, wherein the controller is connected to a network connectivity device.

9. The interactive display stand of claim 8, wherein the controller can be updated via information transmitted through the network connectivity device.

10. The interactive display stand of claim 8, further comprising a sensor for determining an amount of printed material in the plurality of locations, the sensor being connected to the network connectivity device.

11. The interactive display stand of claim 7, wherein the output device is a graphical output device.

12. The interactive display stand of claim 11, wherein the graphical output device displays material selected from the group consisting of video content, dynamic text, dynamic graphics, static text, static graphics, and any combination thereof.

13. The interactive display stand of claim 11, wherein the graphical output device comprises a printer.

14. The interactive display stand of claim 7, wherein the output device is an audio output device.

15. The interactive display stand of claim 7, wherein the output device is an olfactory device.

16. The interactive display stand of claim 15, wherein the olfactory device produces scents associated with an input received through the input device.

17. The interactive display stand of claim 15, wherein the olfactory device produces scents associated with the printed material contained in the plurality of locations.

18. The interactive display stand of claim 7, wherein the input device comprises a temperature-regulating device.

19. The interactive display stand of claim 7, wherein the input device comprises a device selected from the group consisting of a touch screen, a payment device, a sensor, a scanner, and any combination thereof.
